(19) United States
(12) Patent Application Publication
(10) Pub. No.: US 2004/0230376 A1
(43) Pub. Date: Nov. 18, 2004

(54) Vehicle traveling speed pattern estimation device/method

(76) Inventors: Shinji Ichikawa, Aichi (JP); Yukikazu Koide, Aichi (JP); Shinji Doki, Mie (JP); Shigeru Okuma, Aichi (JP); Nobuaki Miki, Aichi (JP); Takashi Naitou, Aichi (JP)

Correspondence Address: LORUSSO & LOUD, 3137 Mount Vernon Avenue, Alexandria, VA, 22305, US

(21) Appl. No.: 10/788,425

(22) Filed: Mar. 1, 2004

(30) Foreign Application Priority Data
Mar. 13, 2003 (JP) 2003-68685

(51) Int. Cl. G06F 19/00

(52) U.S. Cl. 702/2

(57) ABSTRACT

In estimating a traveling speed pattern on the basis of the past traveling data, the present invention aims at making it possible to efficiently estimate the traveling speed pattern without referring to an enormous volume of the past traveling data, and preventing the precision of estimation from deteriorating due to a decrease in the number of the available past data. To achieve this object, a vehicle traveling speed pattern estimation device of the present invention comprises traveling information storing means for storing traveling data and traveling environment data as mutually associated data, candidate traveling speed pattern generating means for generating a candidate traveling speed pattern on the basis of the traveling data, and estimated traveling speed pattern outputting means for extracting a candidate traveling speed pattern matching current traveling environment data and outputting an estimated traveling speed pattern for a route to be followed from now on.

### INCORPORATION BY REFERENCE

The disclosure of Japanese Patent Application No. 2003-068685 filed on Mar. 13, 2003 including the specification, drawings and abstract is incorporated herein by reference in its entirety.

### BACKGROUND OF THE INVENTION

1. Field of Invention

The present invention relates to a vehicle traveling speed pattern estimation device/method.

2. Description of Related Art

Heretofore, a hybrid vehicle that employs, as power sources thereof, both an engine such as an internal combustion engine or the like and a motor such as an AC motor or the like that is caused to rotate by electric power supplied from an electric charge accumulation means such as a battery (a secondary battery such as an accumulator battery) or the like has been provided. In the hybrid vehicle, the motor as one of the power sources functions as a generator during deceleration of the vehicle. In the case where so-called regenerative current is generated, the regenerative current is supplied to the battery during deceleration of the vehicle, so that the battery is charged again. Thus, the battery is constantly charged, and current is automatically supplied to the motor from the battery via an inverter, for example, in the case where an output of the engine is below a required output. Therefore, the vehicle can stably travel in various traveling modes. Further, the amount of fuel consumed by the engine can be reduced.

To minimize the amount of fuel consumed by the engine, there is provided an art for setting operational schedules for the engine and the motor in such a manner as to minimize the amount of fuel consumption in accordance with traffic circumstances of a route to a destination (e.g., see Japanese Patent Application Laid-Open No. 2000-333305, Japanese Patent Application Laid-Open No. 2001-183150, and Japanese Patent Application Laid-Open No. 2003-9310). In this case, the route to the destination is divided into a plurality of sections, a traveling speed pattern for each of the sections is estimated by acquiring road data and traveling history from a navigation system, and operational schedules for the engine and the motor are so set as to minimize the amount of fuel consumed before arriving at the destination, on the basis of the estimated traveling speed pattern and fuel consumption characteristics of the engine.

However, in the above-mentioned vehicle traveling speed pattern estimation device of the related art, the precision in estimating a traveling speed pattern is low, and an attempt to enhance the precision of estimation leads to an increase in the burden of estimation processings.

As a rule, in the case where a traveling speed pattern is estimated, it is desirable that the traveling speed pattern be estimated on the basis of the past traveling data on a route that is estimated to be followed from now on. In the vehicle traveling speed pattern estimation device disclosed in Japanese Patent Application Laid-Open No. 2000-333305, a traveling speed pattern for a route to be followed from now on is estimated on the basis of the past traveling data and various road attributes (classes such as expressway, open road, urban area, and the like). However, in a vehicle traveling speed pattern estimation method disclosed in Japanese Patent Application Laid-Open No. 2000-333305, since data on routes other than the route to be followed from now on are also included in the past traveling data, the precision in estimating a traveling speed pattern for the route to be followed from now on deteriorates.

In the vehicle traveling speed pattern estimation device disclosed in Japanese Patent Application Laid-Open No. 2000-333305, a traveling speed pattern is estimated in accordance with time zone, day of the week, and the like. In this case, when making use of the past data on a route that is estimated to be followed from now on, the precision in estimating a traveling speed pattern can be enhanced by an attempt to carry out estimation on the basis of the past data matching conditions of traveling environments to be passed from now on, in accordance with time zone, day of the week, and the like. However, if the past data available for estimation are screened in accordance with day of the week or time zone, the number of the available past data is reduced, and the precision of estimation deteriorates contrary to the intention of enhancing it. Further, if accumulation of the past traveling data goes on, the volume of the accumulated data becomes enormous. If data of an enormous volume are utilized as the past traveling data in estimating a traveling speed pattern, the burden of calculation processings increases, and the installation of high-performance calculation means becomes necessary.

### SUMMARY OF THE INVENTION

As a solution to the problems of the vehicle traveling speed pattern estimation device of the aforementioned related art, the present invention aims at providing a vehicle traveling speed pattern estimation device/method which makes it possible to efficiently estimate a traveling speed pattern without referring to an enormous volume of the past traveling data in estimating the traveling speed pattern on the basis of the past traveling data, and which prevents the precision of estimation from deteriorating due to a decrease in the number of the available past data.

To achieve this object, according to one aspect of the present invention, a vehicle traveling speed pattern estimation device comprises traveling information storing means for storing traveling data and traveling environment data as mutually associated data, candidate traveling speed pattern generating means for generating a candidate traveling speed pattern on the basis of the traveling data, and estimated traveling speed pattern outputting means for extracting a candidate traveling speed pattern matching current traveling environment data and outputting an estimated traveling speed pattern for a route to be followed from now on.

In the above-mentioned aspect of the present invention, the vehicle traveling speed pattern estimation device may further comprise frequent route specifying means for specifying a frequent route on the basis of the traveling data, and sectionally dividing means for dividing the frequent route into short sections. In this vehicle traveling speed pattern estimation device, the candidate traveling speed pattern generating means may generate the candidate traveling speed pattern for each of the short sections, and the estimated traveling speed pattern outputting means may extract a candidate traveling speed pattern for each of the short sections and output an estimated traveling speed pattern for a frequent route to be followed from now on.

In the above-mentioned aspect of the present invention, the candidate traveling speed pattern generating means may classify the traveling data for each of the short sections on the basis of an average traveling speed for each of the short sections or a degree of similarity among traveling speed patterns for each of the short sections, and generate a traveling speed pattern representing a set of the classified traveling data for each of the short sections as the candidate traveling speed pattern.

In the above-mentioned aspect of the present invention, the estimated traveling speed pattern outputting means may extract traveling data matching current traveling environment data for each of the short sections, extract a candidate traveling speed pattern representing a set to which a greatest number of the traveling data belong, and output the estimated traveling speed pattern.

In the above-mentioned aspect of the present invention, the traveling environment data may include date, hour, day of the week, information on operation of on-vehicle equipments such as a wiper and a headlight, and sensing information obtained from on-vehicle sensors such as a raindrop sensor.

In another aspect of the present invention, a vehicle traveling speed pattern estimation method comprises the steps of storing traveling data and traveling environment data as mutually associated data, generating a candidate traveling speed pattern on the basis of the traveling data, and extracting a candidate traveling speed pattern matching current traveling environment data and outputting an estimated traveling speed pattern for a route to be followed from now on.

### BRIEF DESCRIPTION OF THE DRAWINGS

FIG. 1 is a conceptual diagram showing the construction of a drive control system of a hybrid vehicle in an embodiment of the present invention;

FIG. 2 shows an example of a drive control table of the hybrid vehicle in the embodiment of the present invention;

FIG. 3 is a flowchart showing the overall operation of a vehicle traveling speed pattern estimation device in the embodiment of the present invention;

FIG. 4 is a flowchart showing an operation of a frequent route specification processing in the embodiment of the present invention;

FIG. 5 shows an example in which a frequent route in the embodiment of the present invention is divided into a plurality of short sections;

FIG. 6 shows an example of traveling data on short sections in the embodiment of the present invention;

FIG. 7 shows a first example of traveling data on classified short sections in the embodiment of the present invention;

FIG. 8 shows a second example of traveling data on classified short sections in the embodiment of the present invention;

FIG. 9 shows a third example of traveling data on classified short sections in the embodiment of the present invention;

FIG. 10 shows a first example of a representative traveling speed pattern for classified short sections in the embodiment of the present invention;

FIG. 11 shows a second example of a representative traveling speed pattern for classified short sections in the embodiment of the present invention;

FIG. 12 shows a third example of a representative traveling speed pattern for classified short sections in the embodiment of the present invention;

FIG. 13 shows an example of classification of traveling data on all the short sections of a frequent route in the embodiment of the present invention;

FIG. 14 is a flowchart showing an operation of a candidate traveling speed pattern generation processing in the embodiment of the present invention;

FIG. 15 shows an example of estimation of traveling data on all the short sections of a frequent route in the embodiment of the present invention;

FIG. 16 is a flowchart showing an operation of a traveling speed pattern estimation processing in the embodiment of the present invention;

FIG. 17 shows a first example of a set schedule in the embodiment of the present invention;

FIG. 18 shows a second example of a set schedule in the embodiment of the present invention;

FIG. 19 is a flowchart showing an operation of a scheduling processing in the embodiment of the present invention; and

FIG. 20 is a flowchart showing an operation of a traveling processing in the embodiment of the present invention.

### DETAILED DESCRIPTION OF PREFERRED EMBODIMENT

Hereinafter, an embodiment of the present invention will be described in detail with reference to the drawings.

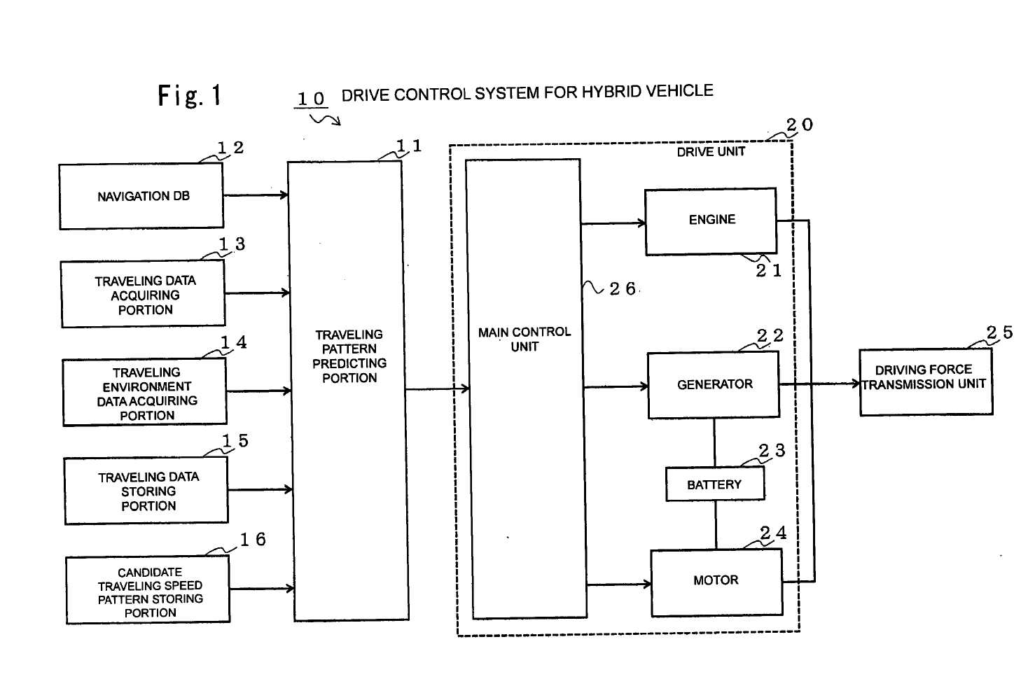

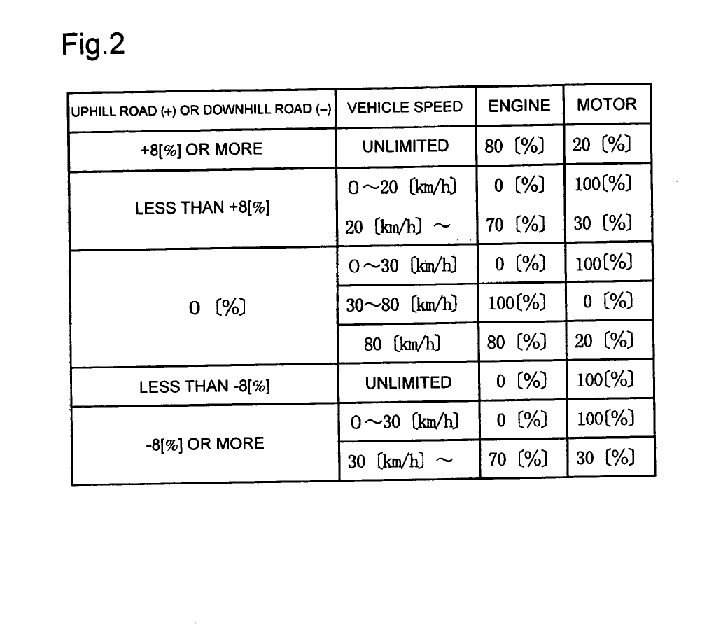

FIG. 1 is a conceptual diagram showing the construction of a drive control system of a hybrid vehicle in the embodiment of the present invention. FIG. 2 shows an example of a drive control table of the hybrid vehicle in the embodiment of the present invention.

Referring to FIG. 1, a reference numeral 10 denotes a drive control system of a hybrid vehicle as a vehicle traveling speed pattern estimation device in the present embodiment, and a reference numeral 20 denotes a drive unit. A reference numeral 21 denotes an engine such as an internal combustion engine or the like which is driven by fuel such as gasoline, light oil, or the like. The engine 21 is provided with an engine control unit such as an ECU (not shown) or the like, and is used as a power source for a vehicle such as a passenger car, a bus, a truck, or the like. A driving force of the engine 21 is transmitted to a driving force transmission unit 25, which is provided with a transmission (not shown), a drive shaft (not shown), driving wheels (not shown), and the like. The vehicle is driven by rotation of the driving wheels. A braking unit such as a drum brake, a disc brake, or the like can also be disposed in the driving force transmission unit 25.

It is to be noted herein that the vehicle is a hybrid vehicle. This hybrid vehicle has a motor 24 such as an electrically rotated AC motor or the like, and utilizes both the engine 21 and the motor 24 as vehicular power sources. The motor 24 generates a driving force by electric power supplied from a battery 23 as electric charge accumulation means. The driving force is transmitted to the driving wheels of the driving force transmission unit 25. A generator 22 such as an AC generator or the like is connected to the driving force transmission unit 25. The generator 22 generates a regenerative current during deceleration of the vehicle. The regenerative current generated by the generator 22 is supplied to the battery 23, whereby the battery 23 is charged. The generator 22 can also be caused to generate current by a driving force of the engine 21. It is desirable that the motor 24 be an AC motor. In this case, the motor 24 is provided with an inverter (not shown). By the same token, it is also desirable that the generator 22 be an AC generator. In this case, the generator 22 is provided with an inverter (not shown). In addition, the battery 23 is provided with a capacity detecting sensor (not shown) for detecting an SOC (State Of Charge) as an electric charge accumulation amount.

The motor 24 may be constructed integrally with the generator 22. In this case, the motor 24 generates a driving force and functions as a power source when being supplied with electric power from the battery 23, and functions as the generator 22 for generating regenerative current when being rotated by the driving force transmission unit 25 as in the case of braking or the like of the vehicle.

The battery 23 is a secondary battery as electric charge accumulation means that allows charge and discharge of electricity repeatedly. In general, a lead-acid battery, a nickel-cadmium battery, a nickel-hydrogen battery, or the like is used as the battery 23. However, the battery 23 may also be a high-performance lead-acid battery for use in an electric vehicle or the like, a lithium ion battery, a sodium-sulfur battery, or the like. It is not absolutely required that the electric charge accumulation means be the battery 23. The electric charge accumulation means may be realized in any form as long as it has functions of storing energy as electricity and discharging electricity. For example, the electric charge accumulation means may be a condenser (capacitor) such as an electric double layer condenser, a flywheel, a superconducting coil, a pressure accumulator, or the like. Furthermore, while one of the components mentioned herein may be used alone, some of them may also be used by being combined with one another. For example, the battery 23 and the electric double layer condenser may be combined with each other to be used as the electric charge accumulation means.

A reference numeral 26 denotes a main control unit, which is a sort of computer including calculation means such as a CPU (not shown), an MPU (not shown) and the like, storage means such as a semiconductor memory, a magnetic disk and the like, a communication interface, and the like. The main control unit 26 controls operations of the engine 21, the engine control unit, the motor 24, the generator 22, and the inverter on the basis of signals from a traveling pattern predicting portion 11, the capacity detecting sensor, and various sensors in a traveling data acquiring portion 13. The aforementioned sensors include an accelerator sensor, a brake sensor, and the like. These sensors detect pieces of information on operations performed by a driver of the vehicle, and transmits them to the main control unit 26.

The main control unit 26 usually controls a usage ratio between the engine 21 and the motor 24 in accordance with the traveling situation of the vehicle, for example, as shown in FIG. 2. In this case, the output during travel of the vehicle is defined as 100[%]. Namely, the sum of an output from the engine 21 and an output from the motor 24 is defined as 100[%]. For instance, while the engine 21 and the motor 24 may be operated respectively with usage ratios of 80[%] and 20[%] with respect to a total output of the vehicle on a uphill road of +8[%] or more, they may also be operated respectively with usage ratios of 70[%] and 30[%] with respect to the total output of the vehicle. The values set herein are examples and may be replaced with other values. The usage ratios shown in FIG. 2 afford nothing more than an example. That is, numerical values shown below titles of “UPHILL ROAD (+) OR DOWNHILL ROAD (−)”, “VEHICLE SPEED”, “ENGINE”, and “MOTOR” can be changed appropriately. In addition, it is also appropriate that the usage ratios of the engine 21 and the motor 24 with respect to the total output during travel of the vehicle be set using a table utterly different from the one shown in FIG. 2.

Referring to FIG. 1, a reference numeral 12 denotes a navigation data base where pieces of navigation information as data to be used for a navigation processing in a generally available navigation system, for example, map data, road data, search data, and the like are stored. Referring also to FIG. 1, a reference numeral 14 denotes a traveling environment data acquiring portion for acquiring data on the traveling environment of the vehicle such as time, date, traffic congestion information, weather information, and the like. The traveling data acquiring portion 13 is provided with various sensors, and acquires data on the traveling state of the vehicle such as vehicle speed, operational state of a brake, accelerator opening, and the like. The traveling pattern predicting portion 11 is a sort of computer including calculation means such as a CPU (not shown), an MPU (not shown) and the like, storage means such as a semiconductor memory, a magnetic disk and the like, a communication interface, and the like. The traveling pattern predicting portion 11 acquires data from the navigation data base 12, the traveling data acquiring portion 13, and the traveling environment data acquiring portion 14, performs a navigation processing such as display of a current position of the vehicle, search of a route to a destination, and the like, and a traveling speed pattern estimation processing of estimating a traveling speed pattern reflecting driving characteristics of the driver. It is desirable that the traveling pattern predicting portion 11 be provided with an input portion, a display portion, a speech input portion, a speech output portion, and a communicative portion. The input portion is provided with an operational key (not shown), a press button, a jogdial®, a cruciform key, a remote controller, or the like. The display portion is provided with a CRT display, a liquid-crystal display, an LED (Light Emitting Diode) display, a plasma display, a hologram system for projecting a hologram onto a wind shield, or the like. The speech input portion is composed of a microphone and the like. The speech output portion is provided with a speech synthesizer, a loudspeaker, and the like. The communicative portion exchanges various data with an FM transmitter, a telephone line network, internet, a mobile phone network, and the like.

The navigation data base 12 is provided with a data base composed of various data files. The navigation data base 12 records not only search data for searching a route but also various data such as map data, facility data, and the like, with a view to displaying a guide map on a screen of the display portion along a searched route, displaying a photo, a frame shot, or the like that is characteristic of an intersection or a route, displaying a distance to the next intersection, a traveling direction at the next intersection, and the like, and displaying other pieces of guide information. Various data for outputting predetermined pieces of information by the speech output portion are also recorded in the navigation data base 12.

The search data include intersection data, road data, traffic regulation data, and route display data. In addition to the number of intersections whose data are stored, data on the respective intersections are stored in the above-mentioned intersection data, as intersection data accompanied by identification numbers respectively. Moreover, in addition to the number of roads connected to each of the intersections, namely, the number of connecting roads, numbers for identifying the connecting roads are stored as attachments in a corresponding one of the intersection data. Intersection types may be included in the intersection data. Namely, data for determining whether or not each of the intersections is equipped with traffic signals may be included in the intersection data.

In addition to the number of roads whose data are stored, data on the respective roads are stored in the above-mentioned road data, as road data accompanied by identification numbers respectively. In each of the road data, a type of a corresponding one of the roads, a distance as a length of that road, a traveling time as a time required for travel along that road, and the like are stored. The type of the road includes an administrative road attribute such as national highway, prefectural highway, main regional road, open road, expressway, or the like.

It is desirable that the road data include road-related data such as a width, a gradient, a cant, an altitude, a bank, a road surface state, the presence of a median strip, the number of lanes, a position where the number of lanes decreases, a position corresponding to a narrowed width, and the like. Opposite lanes of an expressway or a trunk road are stored as separate road data and treated as a two-rowed road. For example, a trunk road having two or more lanes on one side thereof is treated as a two-rowed road. The up and down lanes of the trunk road are stored in the road data as mutually independent roads. Furthermore, as for a corner, it is preferable to include data on radius of curvature, intersection, T-junction, corner entry position, and the like. Road attributes such as railroad crossing, ramp at entrance or exit of expressway, toll gate for expressway, downhill road, uphill road, and the like may also be included.

The data in the navigation data base 12 are stored in storage means such as a semiconductor memory, a magnetic disk, or the like. The storage means may be a storage medium of any form such as a magnetic tape, a magnetic disk, a magnetic drum, a flash memory, a CD-ROM, an MD, a DVD-ROM, an optical memory disk, an MO, an IC card, an optical memory card, a memory card, and the like. It is also possible to use an external storage medium that can be removed.

The traveling data acquiring portion 13 has a GPS sensor for receiving GPS information from a GPS (Global Positioning System) satellite, an orientation sensor for detecting a direction in which a vehicle is oriented, an accelerator opening sensor for detecting an opening of an accelerator, a brake switch for detecting a movement of a brake pedal operated by the driver, a steering sensor for detecting a steering angle of a steering wheel operated by the driver, a turn signal sensor for detecting a movement of a turn signal lever operated by the driver, a shift lever sensor for detecting a movement of a shift lever of the transmission operated by the driver, a vehicle speed sensor for detecting a traveling speed of the vehicle, namely, a vehicle speed, an acceleration sensor for detecting an acceleration of the vehicle, a yaw rate sensor for detecting a yaw rate indicative of a change in the direction in which the vehicle is oriented, and the like. The traveling data include a current position of the vehicle, an opening of the accelerator, a movement of the brake pedal operated by the driver, a steering angle of the steering wheel operated by the driver, a movement of the turn signal lever operated by the driver, a movement of the shift lever of the transmission operated by the driver, a vehicle speed, an acceleration of the vehicle, a yaw rate indicative of a change in the direction in which the vehicle is oriented, and the like.

The traveling data acquiring portion 13 acquires traveling data such as a current position of the vehicle, a traveling speed of the vehicle, and the like at predetermined intervals between start and stop of the vehicle, namely, between start and stop of the drive unit 20. That is, the traveling data acquiring portion 13 acquires traveling data at intervals of a predetermined period (e.g., every time a predetermined period such as 100[msec], 1[sec], or the like elapses) or at intervals of a predetermined distance (e.g., every time a predetermined distance such as 100 [m], 500 [m], or the like is covered). The acquisition of traveling data at predetermined intervals as described herein makes it possible to obtain traveling loci of the vehicle and moment-to-moment changes in traveling speed of the vehicle, namely, a traveling speed pattern of the vehicle. The traveling data thus acquired can be utilized to produce or estimate a traveling speed pattern in the traveling pattern predicting portion 11.

The traveling environment data acquiring portion 14 is provided with a clock, a calendar, and the like. The traveling environment data acquiring portion 14 acquires and stores pieces of date-and-time information such as a current time, a date, a day of the week, a date and time of departure of the vehicle, and the like. Further, the traveling environment data acquiring portion 14 acquires and stores pieces of traffic information, such as pieces of information on traffic congestion and the like, pieces of information on traffic regulations, pieces of information on road constructions, and the like. These pieces of information are prepared by gathering information from traffic control systems of Japan Public Roads Administration, the police, and the like, for example, using a road traffic information communication system called VICS(R) (Vehicle Information & Communication System). In addition, it is also desirable that the traveling environment data acquiring portion 14 acquire and store pieces of event information such as planned spots, dates, hours, and the like for organizing events such as festivals, parades, fireworks displays, and the like. For instance, it is also desirable that the traveling environment data acquiring portion 14 acquire and store statistical pieces of traffic congestion information on the possibility of traffic congestion on roads in the neighborhood of a railway station or a major commercial establishment at a certain hour of workdays and the possibility of traffic congestion on roads in the neighborhood of a bathing beach during the summer vacation, pieces of weather information such as a weather forecast produced by the Japanese Meteorological Agency, and the like. The traveling environment information as the pieces of information on the environment in which the vehicle travels, which are acquired and stored by the traveling environment data acquiring portion 14, includes a current time, a date, a day of the week, a date and hour of departure of the vehicle, the weather, traffic congestion information, traffic regulation information, road construction information, event information, and the like.

The traveling environment data acquiring portion 14 also acquires data on operating conditions of on-vehicle equipments such as a wiper, a headlight, an air-conditioner, a defroster, and the like, and sensing data obtained from on-vehicle sensors such as a raindrop sensor, an air temperature sensor, and the like. The data on the operating conditions of the on-vehicle equipments and the sensing data can be utilized to estimate a weather at each moment in the traveling pattern predicting portion 11.

A reference numeral 15 denotes a traveling data storing portion, which stores the traveling data acquired by the traveling data acquiring portion 13 and the traveling environment data acquired by the traveling environment data acquiring portion 14. In this case, the traveling data and traveling environment data during one traveling cycle of the vehicle are stored as mutually associated data. A reference numeral 16 denotes a candidate traveling speed pattern storing portion, which stores traveling speed patterns generated from the past traveling data that will be described later.

In the drive control system 10 for the hybrid vehicle of the present embodiment, if the traveling pattern predicting portion 11 performs the traveling speed pattern estimation processing and estimates a traveling speed pattern, the main control unit 26 sets a schedule relating to the usage ratio between the engine 21 and the motor 24 on the basis of the traveling speed pattern, and controls the operational states of the engine 21 and the motor 24 and the SOC of the battery 23 in accordance with the schedule.

In terms of function, the drive control system 10 for the hybrid vehicle as a vehicle traveling speed estimation device has traveling information storing means, candidate traveling speed pattern generating means, and estimated traveling speed pattern outputting means. The traveling information storing means, which stores traveling data and traveling environment data as mutually associated data, is related to the traveling data storing portion 15. The candidate traveling speed pattern generating means, which generates candidate traveling speed patterns on the basis of traveling data, is related to the traveling pattern predicting portion 11. Furthermore, the estimated traveling speed pattern outputting means, which extracts candidate traveling speed patterns matching current traveling environment data and outputs an estimated traveling speed pattern for a route to be followed from now on, is related to the traveling pattern predicting portion 11. Moreover, the drive control system 10 for the hybrid vehicle may have frequent route specifying means for specifying a frequent route on the basis of the traveling data and sectionally dividing means for dividing the frequent route into short sections. In this case, the frequent route specifying means and the sectionally dividing means are related to the traveling pattern predicting portion 11.

Next, the operation of the drive control system 10 for the hybrid vehicle constructed as described above will be described. First of all, the basic concept of estimating a traveling speed pattern will be described.

As a rule, in a hybrid vehicle, traveling control of the vehicle is performed to match a driver's real-time request for operation and a request made by the electric charge accumulation means. However, generally accepted traveling control of a hybrid vehicle has the following problems (1) to (8).

(1) In a traveling speed pattern wherein the vehicle is stopped immediately after having been accelerated or in a traveling speed pattern wherein the vehicle is frequently accelerated or decelerated, an engine is in operation only for a short period, so that a battery cannot be charged sufficiently in some cases.

(2) Even if the battery is charged with a large amount of electricity while the power required for causing the vehicle to travel is low, the engine may be in operation.

(3) Even if the energy required for causing the vehicle to travel between start and stop thereof is low, the engine may be in operation.

(4) Even if the power required for causing the vehicle to travel is low as in the case of being trapped in traffic congestion or traveling at a low speed, a decrease in the amount of electricity accumulated in the battery may render the engine in operation so as to generate current by means of a generator.

(5) Even if regenerative current is generated as in the case of traveling along a downhill road or decelerating, a certain management range of the SOC of the battery may not permit regeneration.

(6) If the engine is in operation in the case where the energy required for causing the vehicle to travel is low as in the case of traveling at a constant speed, the generator generates current. However, a certain management range of the SOC of the battery may not permit accumulation of electric charges.

(7) Even if the vehicle is decelerating or is about to be stopped, the engine may be in operation.

(8) In summer or the like, even if the vehicle is stopped, the engine may be in operation to keep an air-conditioner in operation.

To solve the problems mentioned above, it is necessary to estimate a traveling speed pattern on a route estimated to be followed from now on, to set an operational schedule for traveling along the route efficiently, and to control the operational states of the engine 21 and the motor 24 and the SOC of the battery 23 in accordance with the operational schedule. In the present embodiment, therefore, candidate traveling speed patterns are produced on the basis of the past data for cases of traveling along routes that are frequently followed for the purpose of going to work, going to school, going shopping, and the like. Then, the one which corresponds to current traveling environment data is extracted from the candidate traveling speed patterns, and a traveling speed pattern on the route estimated to be followed from now on is estimated.

In this case, the routes that are frequently followed are certain routes to be followed almost everyday, for example, a commute route. However, they need not be followed everyday. That is, they may be followed every other day or more or less once a week. Also, these routes need not be followed periodically. That is, the frequency with which they are followed may be determined appropriately. Time zones in which the routes to be frequently followed are followed may be constant as in the case of going to work in the morning, or may vary daily as in the case of going home after work. The distances of the routes to be frequently followed may either be short such as 2 to 3 [km] or be long such as 100 [km]. It is to be noted herein that outward and homeward routes are grasped as different routes as to any one of the above-mentioned routes to be frequently followed. Next, the overall flow of the operation of estimating a traveling speed pattern will be described.

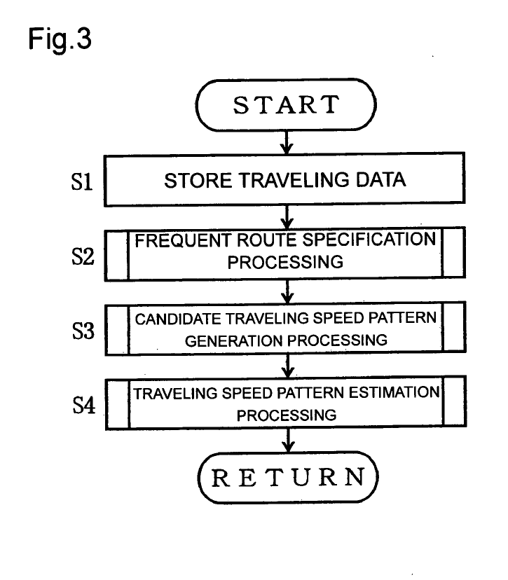

FIG. 3 is a flowchart showing the overall operation of the vehicle traveling speed pattern estimation device in the embodiment of the present invention.

First of all, as in the case where a generally employed navigation system performs a navigation processing, the traveling pattern predicting portion 11 transmits traveling data acquired by the traveling data acquiring portion 13 to the traveling data storing portion 15, which then stores and accumulates the data (step S1). Further, the traveling pattern predicting portion 11 transmits traveling environment data acquired by the traveling environment data acquiring portion 14 to the traveling data storing portion 15, which then stores the data. In this case, the traveling data and traveling environment data during one traveling cycle of the vehicle are stored as mutually associated data. One traveling cycle of the vehicle means a journey between start and stop of the vehicle, namely, a journey between start and stop of the drive unit 20.

Then, the traveling pattern predicting portion 11 performs a frequent route specification processing for specifying a frequently followed route as a frequent route, on the basis of the traveling data stored and accumulated in the traveling data storing portion 15 (step S2). In this case, routes that have been followed by the vehicle a predetermined number of times or more are specified and registered as frequent routes.

Then, the traveling pattern predicting portion 11 performs a candidate traveling speed pattern generation processing for generating a candidate traveling speed pattern (step S3). In this case, the traveling pattern predicting portion 11 divides each of the frequent routes into a plurality of short sections, classifies the past traveling data in each of the short sections usually into a plurality of classes, generates a representative traveling speed pattern for each of the classes on the basis of the traveling data thus classified, and sets the representative traveling speed pattern as a candidate traveling speed pattern. Hence, a plurality of candidate traveling speed patterns are usually generated for each of the short sections. There may also be a short section which corresponds to only one class and for which only a single candidate traveling speed pattern is generated.

Then, the traveling pattern predicting portion 11 performs a traveling speed pattern estimation processing for estimating a traveling speed pattern on a route estimated to be followed from now on (step S4). In this case, the traveling pattern predicting portion 11 extracts those data which correspond to current traveling environment data from the traveling data accumulated in the traveling data storing portion 15, and selects, for each of the short sections, a candidate traveling speed pattern to which a greatest number of the past traveling data thus extracted belong, as an estimated traveling speed pattern. The traveling pattern predicting portion 11 then connects estimated traveling speed patterns selected for the respective short sections, and outputs them as a traveling speed pattern on the route estimated to be followed from now on.

Next, the frequent route specification processing will be described in detail.

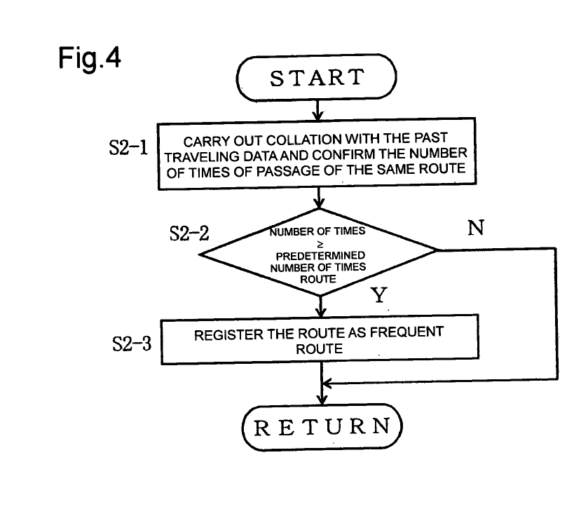

FIG. 4 is a flowchart showing the operation of the frequent route specification processing in the embodiment of the present invention.

First of all, after having acquired traveling data during one traveling cycle of the vehicle, the traveling pattern predicting portion 11 collates the current traveling data thus acquired with the past traveling data accumulated in the traveling data storing portion 15, and confirms how many times the same route as followed this time was followed in the past (step S2-1). In this case, it is more efficient to specify a route followed this time by collating the current traveling data with the data stored in the navigation data base 12 by means of a map matching function utilized in the navigation processing and to confirm how many times the route was followed in the past, than to directly compare the current traveling data with the past traveling data.

Then, the traveling pattern predicting portion 11 determines whether or not the same route as followed this time was followed a predetermined number of times (e.g., ten times) or more (step S2-2). If it is determined that the route was followed the predetermined number of times or more, the traveling pattern predicting portion 11 specifies and registers the route followed this time as a frequent route, and terminates the processing (step S2-3). If it is determined that the route was not followed the predetermined number of times or more, the traveling pattern predicting portion 11 terminates the processing without specifying or registering the route followed this time as a frequent route.

Next, the candidate traveling speed pattern generation processing will be described.

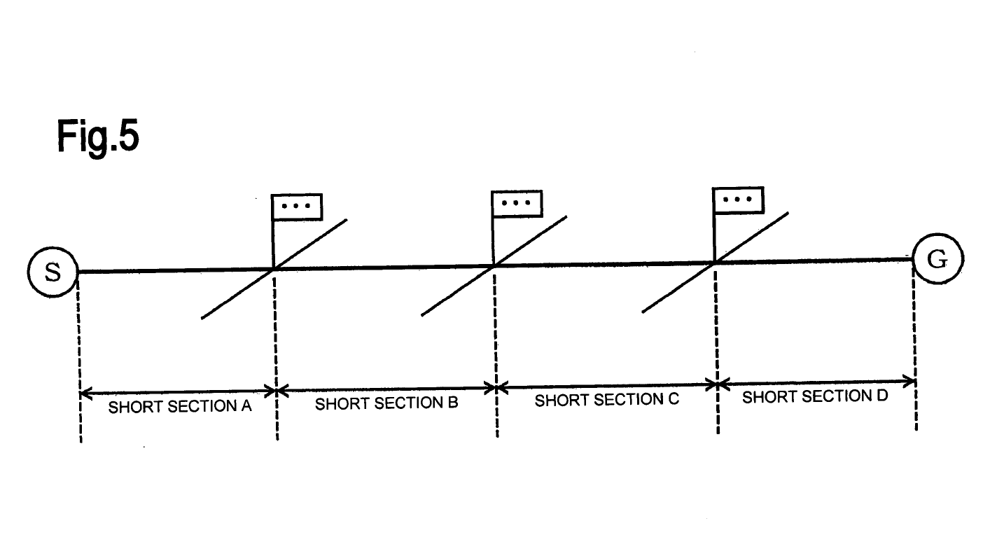

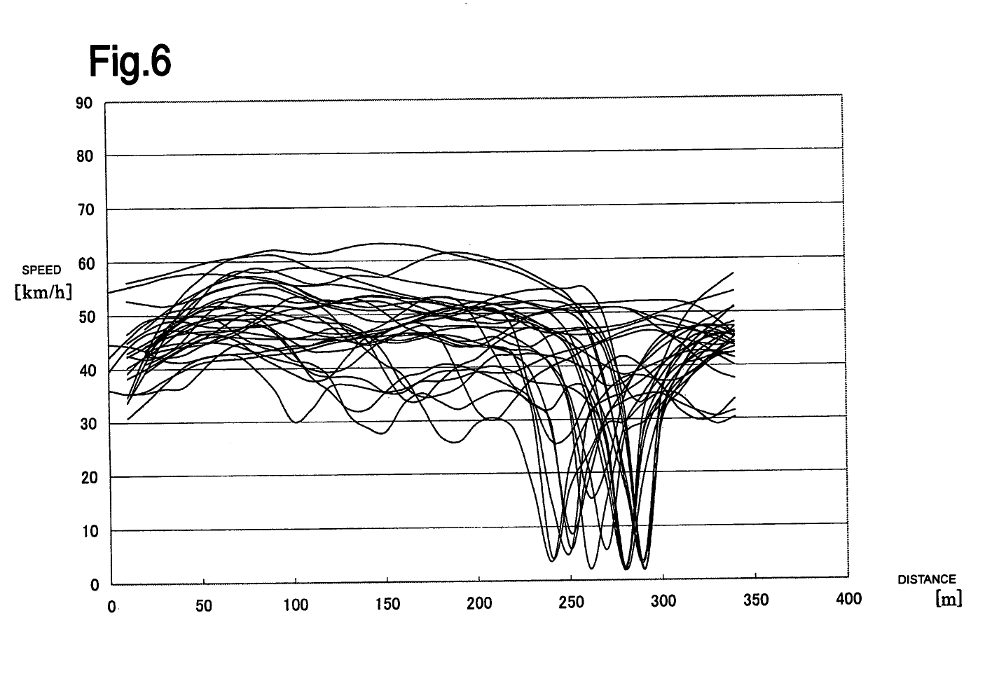

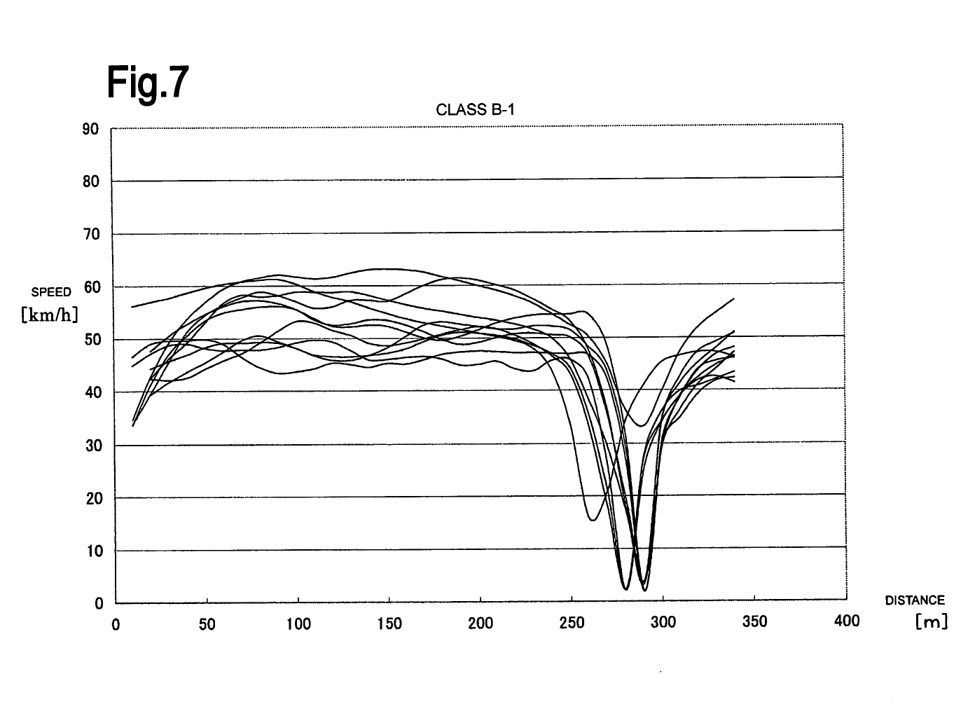

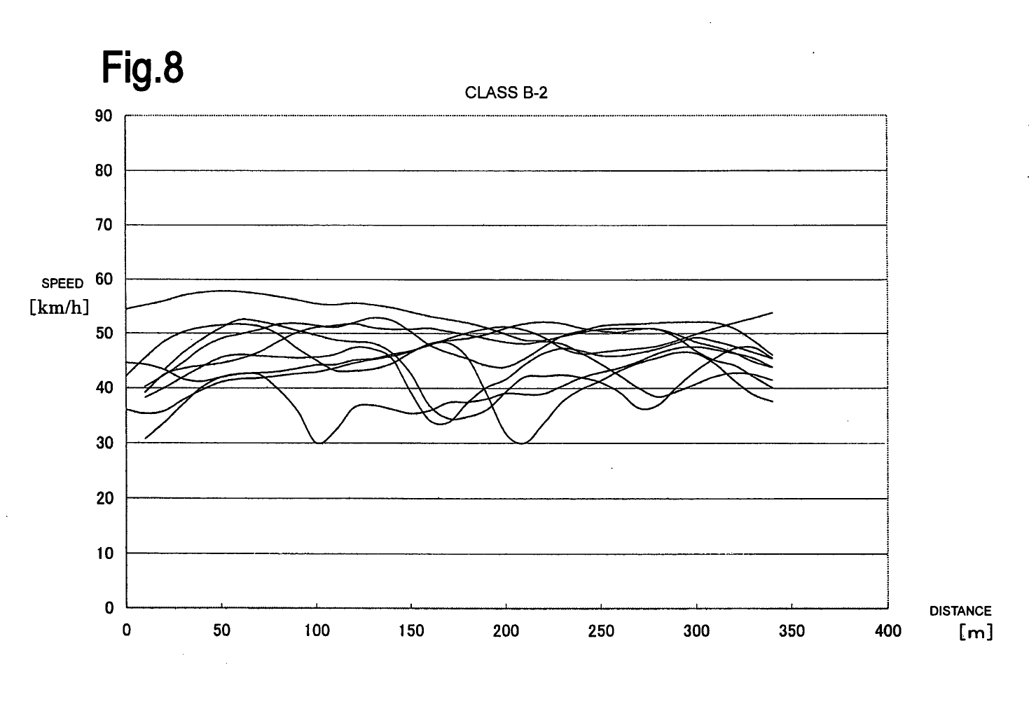

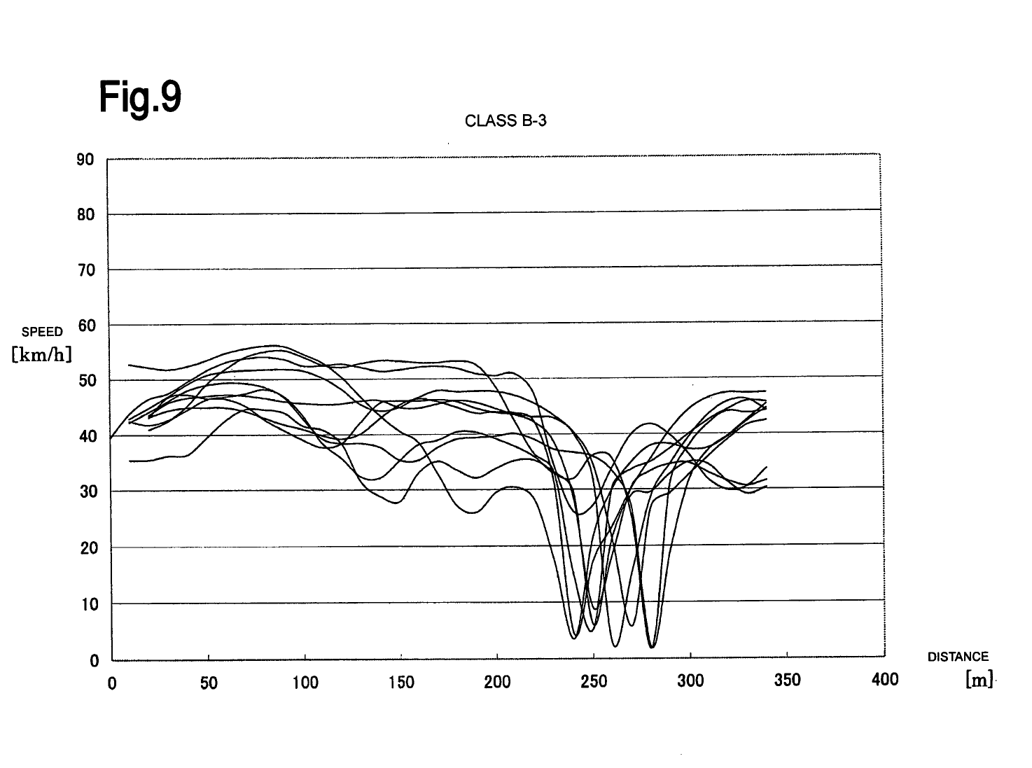

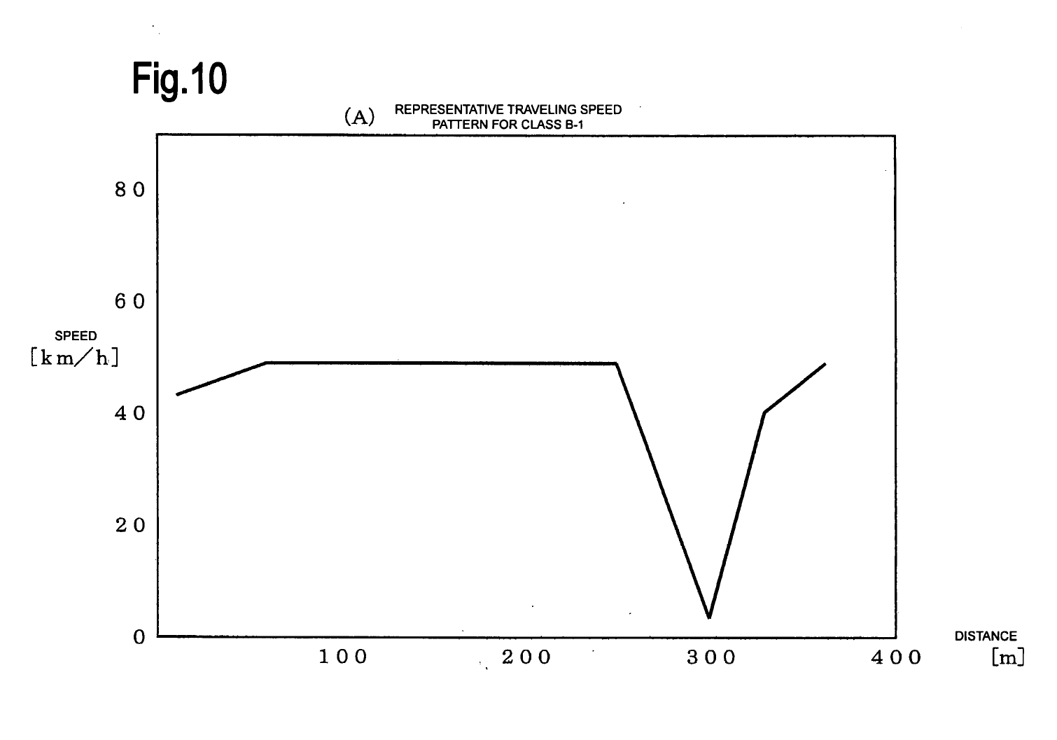

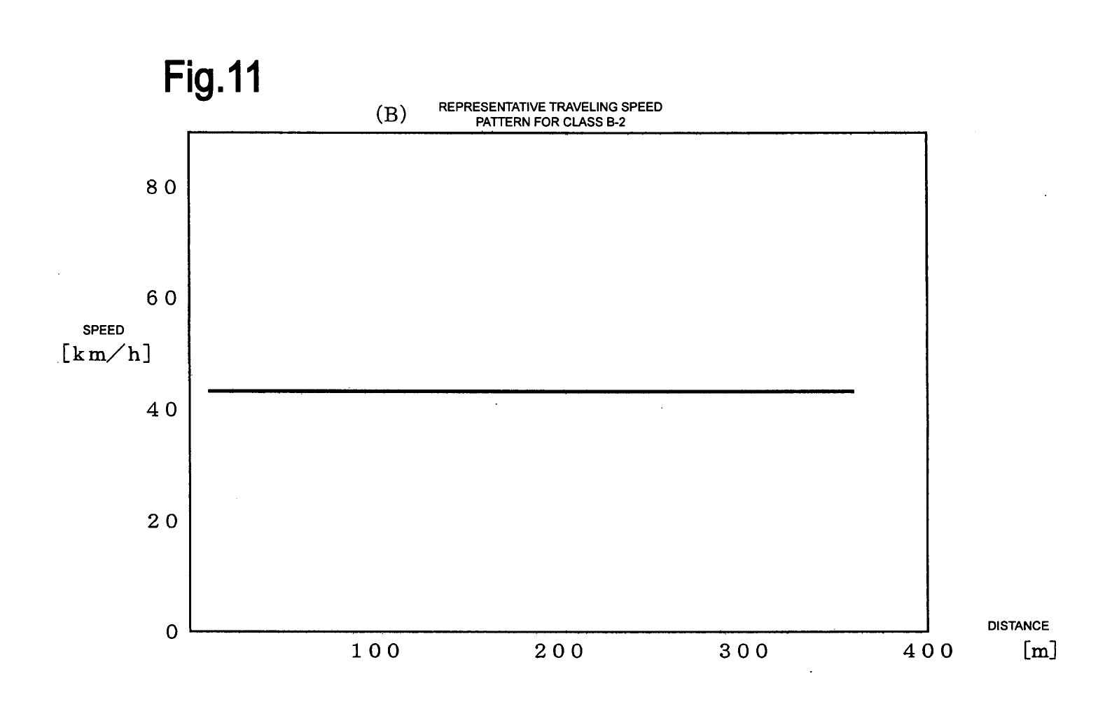

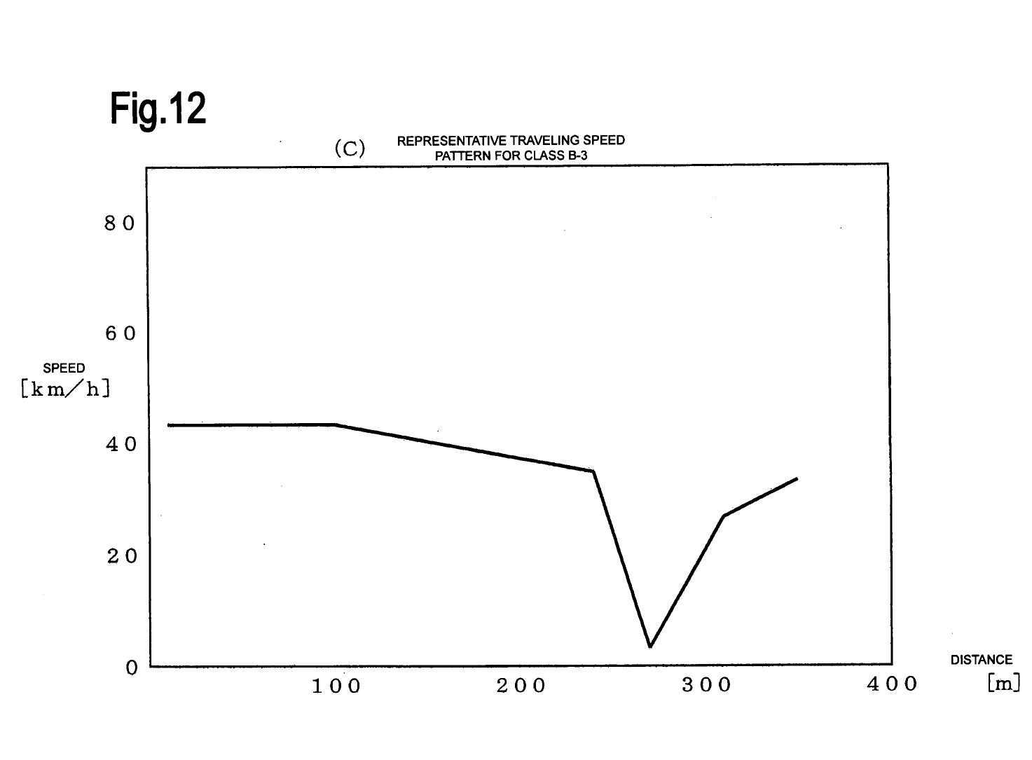

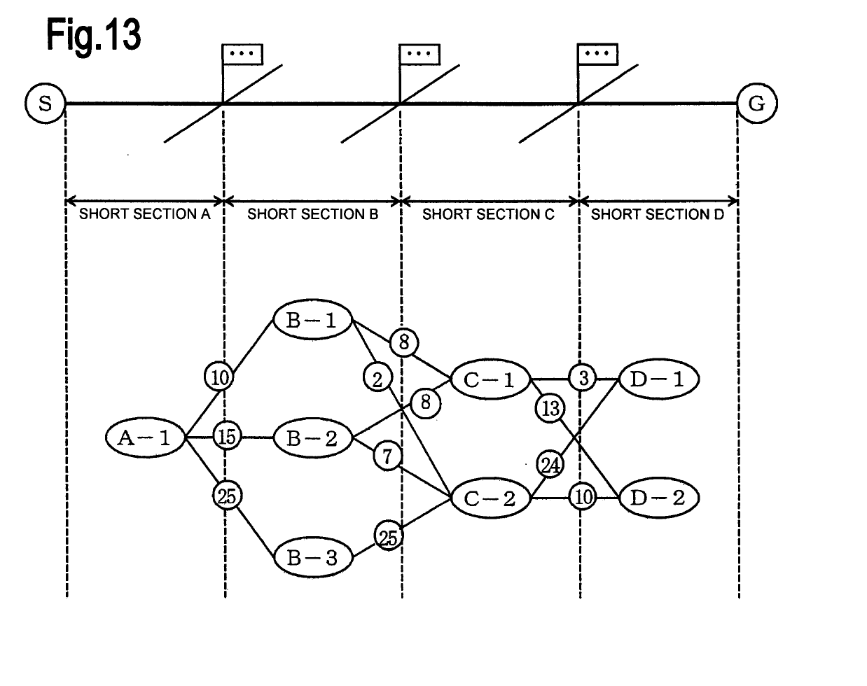

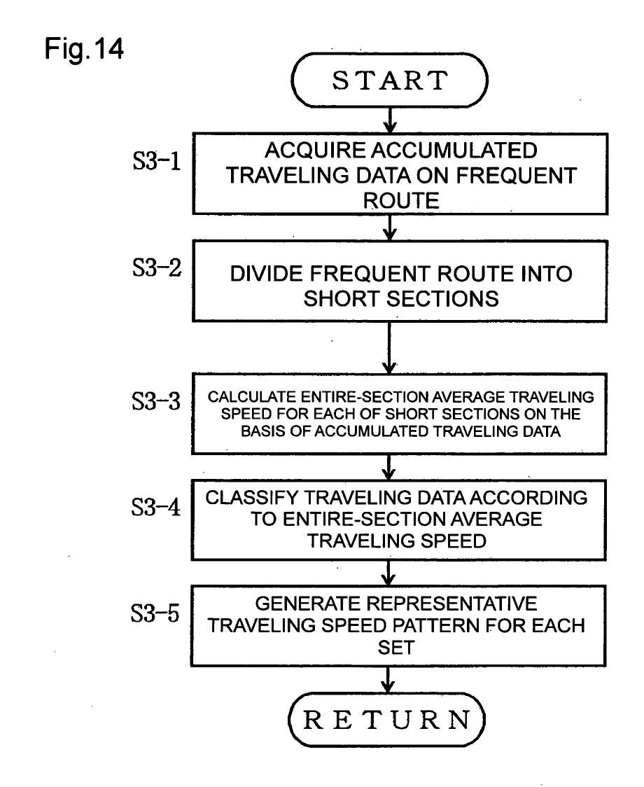

FIG. 5 shows an example in which a frequent route in the embodiment of the present invention is divided into a plurality of short sections. FIG. 6 shows an example of traveling data on short sections in the embodiment of the present invention. FIG. 7 shows a first example of traveling data on classified short sections in the embodiment of the present invention. FIG. 8 shows a second example of traveling data on classified short sections in the embodiment of the present invention. FIG. 9 shows a third example of traveling data on classified short sections in the embodiment of the present invention. FIG. 10 shows a first example of a representative traveling speed pattern for classified short sections in the embodiment of the present invention. FIG. 11 shows a second example of a representative traveling speed pattern for classified short sections in the embodiment of the present invention. FIG. 12 shows a third example of a representative traveling speed pattern for classified short sections in the embodiment of the present invention. FIG. 13 shows an example of classification of traveling data on all the short sections of a frequent route in the embodiment of the present invention. FIG. 14 is a flowchart showing an operation of a candidate traveling speed pattern generation processing in the embodiment of the present invention.

First of all, the traveling pattern predicting portion 11 acquires accumulated traveling data on a registered frequent route from the traveling data storing portion 15 (step S3-1). The traveling pattern predicting portion 11 acquires the road data stored in the navigation data base 12, and divides the frequent route into a plurality of short sections on the basis of the road data (step S3-2).

In the present embodiment, the traveling pattern predicting portion 11 divides the frequent route according to intersections. In general, in the case where a vehicle travels, the vehicle tends to travel without stopping between intersections, and it is considered that the traveling speed pattern between the intersections is likely to be substantially constant because of a road width or a usual degree of congestion. Further, it is considered that traveling speed patterns before and after passing an intersection tend to be greatly different from each other depending on whether or not the vehicle stops at the intersection. Hence, in order to generate candidate traveling speed patters in a short section, it is desirable to divide a frequent route according to intersections. Pieces of information on positions and the like of the intersections are included in the intersection data. It is possible to determine, on the basis of the intersection data, which part of the accumulated traveling data on the frequent route is to be divided. Thus, for each of the intersections, the frequent route is divided into a plurality of short sections, for example, four short sections A to D as shown in FIG. 5. It is to be noted herein that S denotes a start position of the frequent route and that G denotes an end position of the frequent route. The divided traveling data corresponding to the short section B are, for example, as shown in FIG. 6. Referring to FIG. 6, the axis of abscissa represents a distance from a start position of the short section B, the axis of ordinate represents a speed for each distance, and curves represent traveling speed patterns corresponding to the traveling data respectively.

Then, the traveling pattern predicting portion 11 calculates an entire-section average traveling speed in each of the short sections of the frequent route, on the basis of the accumulated traveling data on the frequent route (step S3-3). In this case, the entire-section average traveling speed is an average traveling speed in each of the short sections as a whole, and is calculated as to each of the traveling data. The traveling data are acquired and accumulated every time the frequent route is followed. Therefore, an entire-section average traveling speed in each of the short sections is calculated as to each of the traveling data that are equal in number to the number of times of travel along the frequent route.

The traveling pattern predicting portion 11 extracts those data which have mutually close entire-section average traveling speeds from the traveling data, defines them as one set, and thereby classifies the traveling data into sets based on entire-section average traveling speed (step S3-4). The traveling data are classified as to each of the short sections of the frequent route. In this case, the traveling data are classified, for example, using a clustering method called a “k”-average method.

For instance, the traveling data corresponding to the short section B as shown in FIG. 6 are classified into three sets as is apparent from FIGS. 7, 8, and 9. Referring to FIGS. 7, 8, and 9, the axis of abscissa represents a distance from the start position of the short section B, the axis of ordinate represents a speed for each distance, and curves represent traveling speed patterns corresponding to the traveling data respectively. In this case, if classification is carried out using the clustering method called the “k”-average method on the basis of an entire-section average traveling speed that has been calculated as an average traveling speed in the entire short section B as to each of the curves shown in FIG. 6, classes B-1, B-2, and B-3 as shown in FIGS. 7, 8, and 9 are obtained. It is apparent from FIGS. 7, 8, and 9 that the traveling data in each of the sets classified on the basis of the entire-section average traveling speed have more or less similar traveling speed patterns.

Then, for each of the classified sets, the traveling pattern predicting portion 11 calculates a position average traveling speed at each position between the start and end positions of each of the short sections, using the traveling data belonging to the set. This position average traveling speed is an average traveling speed corresponding to each of the traveling data, for example, at each position that is determined at each predetermined distance from the start position. Then, the traveling pattern predicting portion 11 generates a continuous set of position average traveling speeds at respective positions from the start position to the end position, namely, a transition in the position average traveling speed, and defines the transition in the position average traveling speed as a representative traveling speed pattern of the set (step S3-5).

For example, representative traveling speed patterns as shown in FIGS. 10, 11, and 12 are generated on the basis of the traveling data belonging to the sets of the classes B-1, B-2, and B-3 as shown in FIGS. 7, 8, and 9, respectively. Referring to FIGS. 10, 11, and 12, the axis of abscissa represents a distance from the start position of the short section B, the axis of ordinate represents a speed for each distance, and lines represent representative traveling speed patterns respectively. Each of the representative traveling speed patterns is obtained by calculating position average traveling speeds by simply averaging traveling speeds corresponding to the traveling data at the respective positions, and by continuously connecting the position average traveling speeds from the start position of the short section B to the end position of the short section B.

In calculating a position average traveling speed at each position, it may be calculated by simply averaging traveling speeds corresponding to the respective traveling data at each position. Alternatively, it is also possible to perform weighting by adding a weighting factor that becomes more influential as the degree of newness of traveling data increases. In estimating a traveling speed pattern for each of the short sections in the traveling speed pattern estimation processing, the representative traveling speed pattern is treated as a candidate. In the present embodiment, therefore, the representative traveling speed pattern will be hereinafter referred to as a candidate traveling speed pattern. A candidate traveling speed pattern that has been generated is transmitted to and stored in the candidate traveling speed pattern storing portion 16.

As a method of classifying traveling data into sets, it is possible to utilize a method based on the degree of similarity among traveling speed patterns as well as a method based on the entire-section average traveling speed as mentioned above. When traveling data for each of the short sections is drawn as curves indicating traveling speed patterns in a two-dimensional space wherein the axis of abscissa represents a distance from the start position of the short section and wherein the axis of ordinate represents a speed for each distance as shown in FIG. 6, “the degree of similarity among traveling speed patterns” means the degree of similarity among shapes of the curves. Traveling data whose curves indicating traveling speed patterns are similar to one another are extracted and classified into one set. In this case, the traveling pattern predicting portion 11 performs the following operations (1) and (2).

(1) First of all, some traveling data are arbitrarily selected.

(2) Then, as to each of the selected traveling data:

(2-1) a square of a difference in speed between the selected traveling data and other traveling data (i.e., a square error) at each position between the start and end positions of the short section is calculated; and

(2-2) if the square error at each of the positions is within a predetermined range, the above-mentioned other traveling data are regarded as belonging to the same set as the selected traveling data.

The above-mentioned operations (1) and (2) are thereafter performed repeatedly for each of the short sections.

In the method based on entire-section average traveling speed as mentioned above, traveling data are classified by having each of the traveling data represented by a scalar called entire-section average traveling speed, and by applying the “k”-average method to the scalar. On the other hand, in the method based on the degree of similarity among traveling speed patterns, traveling data are classified by expressing traveling data as vectors called speed sequences, and by applying the “k”-average method to the vectors. Therefore, according to the aforementioned method based on the degree of similarity among traveling speed patterns, despite an increase in the amount of calculation, traveling data having similar traveling speed patterns can be classified more appropriately.

An example of a result of a classification carried out as to all the short sections of a frequent route is illustrated in FIG. 13. In this case, traveling data are classified into one set (A-1) in the short section A, three sets (B-1, B-2, and B-3) in the short section B, two sets (C-1 and C-2) in the short section C, and two sets (D-1 and D-2) in the short section D. In FIG. 13, the sets in the respective short sections are indicated by ellipses respectively. Although not shown, candidate traveling speed patterns corresponding to the respective sets are generated.

Relationships between the sets in the short sections adjacent to each other, namely, between the upstream-side short section (on the left side in the drawing) and the downstream-side short section (on the right side in the drawing) are expressed by segments connecting the sets to one another. Each of numerals surrounded by circles on the segments represents the number of those traveling data which belong to the set(s) in the upstream-side short section and which belong to the sets in the downstream-side short section.

In the example shown in FIG. 13, it is apparent that the total number of traveling data is 50 and that all the traveling data belong to the single set A-1 in the short section A. In the short section B, it is apparent from the segments connecting the sets to one another and the numerals surrounded by the circles on the segments that 10, 15, and 25 out of the 50 traveling data belonging to the set A-1 belong to the sets B-1, B-2, and B-3 respectively. By the same token, in the short section C, eight and two out of the 10 traveling data belonging to the set B-1 belong to the sets C-1 and C-2 respectively. Also, eight and seven out of the 15 traveling data belonging to the set B-2 belong to the sets C-1 and C-2 respectively. It is to be noted herein that all the 25 traveling data belonging to the set B-3 belong to the set C-2. Furthermore, in the short section D, three and 13 out of the 16 traveling data belonging to the set C-1 belong to the sets D-1 and D-2 respectively. Further, 24 and 10 out of the 34 traveling data belonging to the set C-2 belong to the sets D-1 and D-2 respectively.

In the candidate traveling speed pattern generation processing in the present embodiment, no traveling environment data are used. That is, the traveling pattern predicting portion 11 acquires traveling data from the traveling data storing portion 15 without acquiring traveling environment data therefrom, and generates candidate traveling speed patterns on the basis of the traveling data. Hence, traveling data belonging to one set may include, for example, traveling data on rainy days and traveling data on sunny days.

The candidate traveling speed patterns are thus generated not on the basis of the traveling environment data but only on the basis of the traveling data, because even if traveling environments such as days of the week or weather are different, similar traveling speed patterns are obtained irrespective of the traveling environments under certain road circumstances. Under such circumstances, by generating candidate traveling speed patterns only on the basis of traveling data without taking traveling environments into account, it becomes possible to generate candidate traveling speed patterns on the basis of a great number of traveling data, and to enhance the reliability of the candidate traveling speed patterns thus generated. For instance, in the case where there is only one traveling datum on traveling in a rainy environment, namely, in the case where there is only one traveling datum on rainy days, even if a traveling speed pattern on an upcoming rainy day is estimated on the basis of the single traveling datum, the reliability of the estimated traveling speed pattern is low. On the other hand, in the case where there are nine traveling data which do not concern rainy days but have similar traveling speed patterns as well as the traveling datum on rainy days, if a traveling speed pattern on an upcoming rainy day is estimated on the basis of those 10 traveling data, the reliability of the estimated traveling speed pattern is enhanced.

Next, the traveling speed pattern estimation processing will be described.

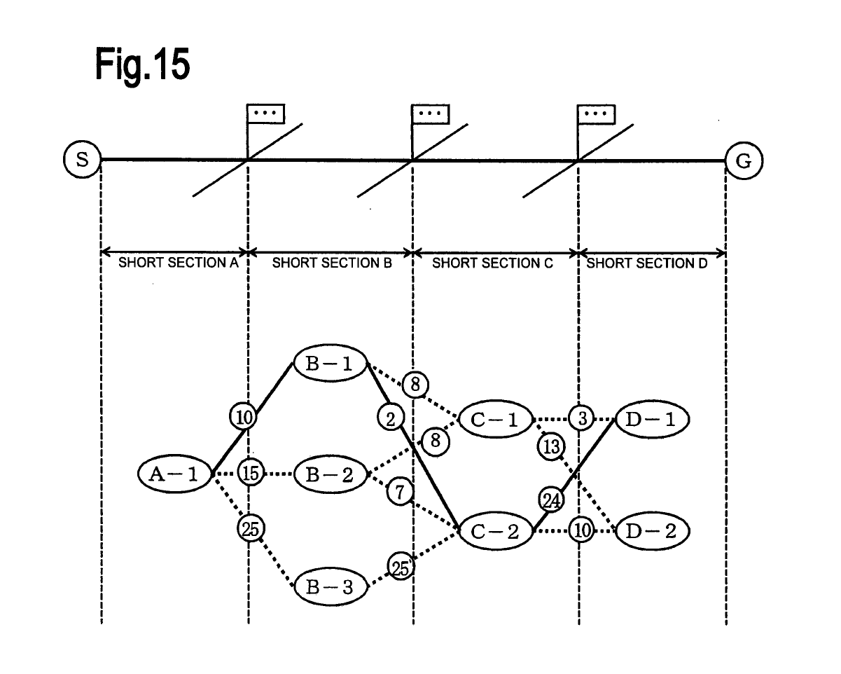

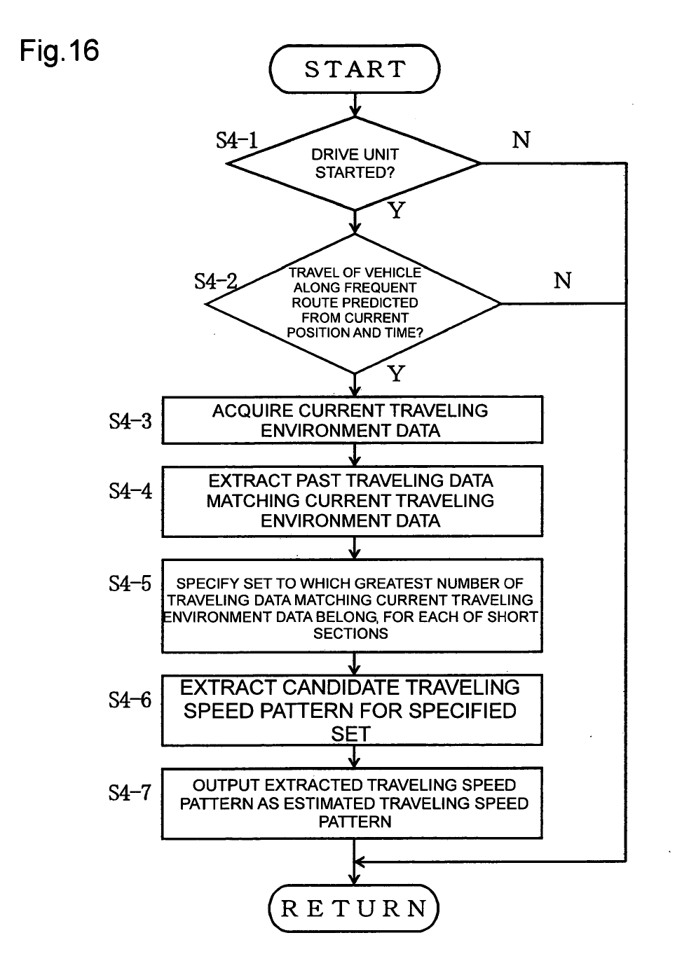

FIG. 15 shows an example of estimation of traveling data on all the short sections of a frequent route in the embodiment of the present invention. FIG. 16 is a flowchart showing an operation of a traveling speed pattern estimation processing in the embodiment of the present invention.

First of all, the traveling pattern predicting portion 11 determines whether or not the drive unit 20 has been started (step S4-1). If the drive unit 20 has been started, the traveling pattern predicting portion 11 acquires a current position of the vehicle and a current time. If the drive unit 20 has not been started, the traveling pattern predicting portion 11 terminates the processing. Referring to the traveling data accumulated in the traveling data storing portion 15, the traveling pattern predicting portion 11 determines whether or not the frequent route is to be followed from now on, on the basis of the acquired current position of the vehicle and the acquired current time (step S4-2). For example, in the case of commute, if the current position is the driver's home and the current time is in a morning commute time zone, it can be determined, referring to the accumulated traveling data, that a commute route registered as the frequent route is to be followed.

If it is not determined that the frequent route is to be followed from now on, the traveling pattern predicting portion 11 terminates the processing. However, if it is determined that the frequent route is to be followed from now on, the traveling pattern predicting portion 11 acquires current traveling environment data such as a day of the week, an operating condition of a wiper, and the like from the traveling environment data acquiring portion 14 (step S4-3). Then, the traveling pattern predicting portion 11 extracts, from the traveling data storing portion 15, the past traveling data matching the current traveling environment data acquired from the traveling environment data acquiring portion 14 (step S4-4). In this case, the traveling data and traveling environment data during one traveling cycle of the vehicle are stored as mutually associated data. Therefore, by carrying out retrieval under the condition of traveling environment data, the traveling data associated with the traveling environment data matching the current traveling environment data can be extracted as traveling data matching the current traveling environment data.

Then, as in the example shown in FIG. 13, the traveling pattern predicting portion 11 specifies, among the sets of the traveling data classified as to all the short sections of the frequent route, a set to which a greatest number of traveling data matching the current traveling environment data belong (step S4-5).

Description will now be made on the basis of the example shown in FIG. 13. For instance, it is assumed that a datum indicating an operating state of the wiper has been acquired as a current traveling environment datum, and that three out of a total of 50 traveling data are associated with the traveling environment datum indicating the operating state of the wiper. In addition, it is assumed that all the three traveling data belong to the set A-1 in the short section A, that two of them and the other one belong to the set B-1 and the set B-2 respectively in the short section B, that one of them and the other two belong to the set C-1 and the set C-2 respectively in the short section C, and that two of them and the other one belong to the set D-1 and the set D-2 respectively in the short section D. In this case, those sets to which a greatest number of traveling data matching the current traveling environment data belong are the sets A-1, B-1, C-2, and D-1. Hence, the traveling speed pattern on the frequent route to be followed from now on can be estimated to be most likely to belong to the sets connected by segments indicated by heavy-line segments in FIG. 15.

Then, the traveling pattern predicting portion 11 extracts a candidate traveling speed pattern of the set specified in each of the short sections from the candidate traveling speed pattern storing portion 16 (step S4-6). The traveling pattern predicting portion 11 outputs the extracted candidate traveling speed pattern as an estimated traveling speed pattern (step S4-7), and terminates the processing.

Thus, in the traveling speed pattern estimation processing, traveling data matching current traveling environment data are extracted, and a candidate traveling speed pattern of a set to which a greatest number of the traveling data belong is extracted as an estimated traveling speed pattern. Hence, a suitable estimated traveling speed pattern matching the current traveling environment data can be output. The estimated traveling speed pattern matching the current traveling environment data is a candidate traveling speed pattern of a set to which a greatest number of traveling data matching the current traveling environment data belong.

As described above, the candidate traveling speed pattern is generated not on the basis of the traveling environment data but only on the basis of the traveling data. That is, the candidate traveling speed pattern is generated on the basis of a great number of traveling data. Hence, even if there are a small number of traveling data matching certain traveling environment data such as those on rainy days, an estimated traveling speed pattern can be output with high precision.

In general, weather, time zone, day of the week, settlement date, end of term, and the like are considered as traveling environments affecting traveling speed patterns. The influence exerted in the above-mentioned case of weather is that the traffic flows slowly as a rule and even the same route is followed at a lower speed if it rains. The influence exerted in the case of time zone is that vehicles travel at low speeds in morning and evening commute time zones because of traffic congestion, and at high speeds in the midnight and the like because of low traffic density. The influence exerted in the case of day of the week is that vehicles travel at high speeds on Sundays because of low traffic density. The settlement date is a day ending with 5 or 0, the last day of the month or the like, which is generally set as a closing date for transaction or accounting. Because the traffic increases in volume on the settlement date, vehicles travel at low speeds. The end of term is the end of March, the end of the year or the like, which is generally set as a settlement period. Because the traffic also increases in volume during the end of term, vehicles travel at low speeds. Moreover, a temporary closure of the traffic that results from an unforeseen traffic accident, traffic congestion of unknown origin, a festival, an event such as a demonstration or the like, fire fighting, or the like, a closure of the traffic or traffic regulation that is caused by a road construction or the like for a predetermined period, and the like can also be considered to be traveling environments affecting traveling speed patterns.

Next, the operation of the drive unit 20 based on the estimated traveling speed pattern will be described.

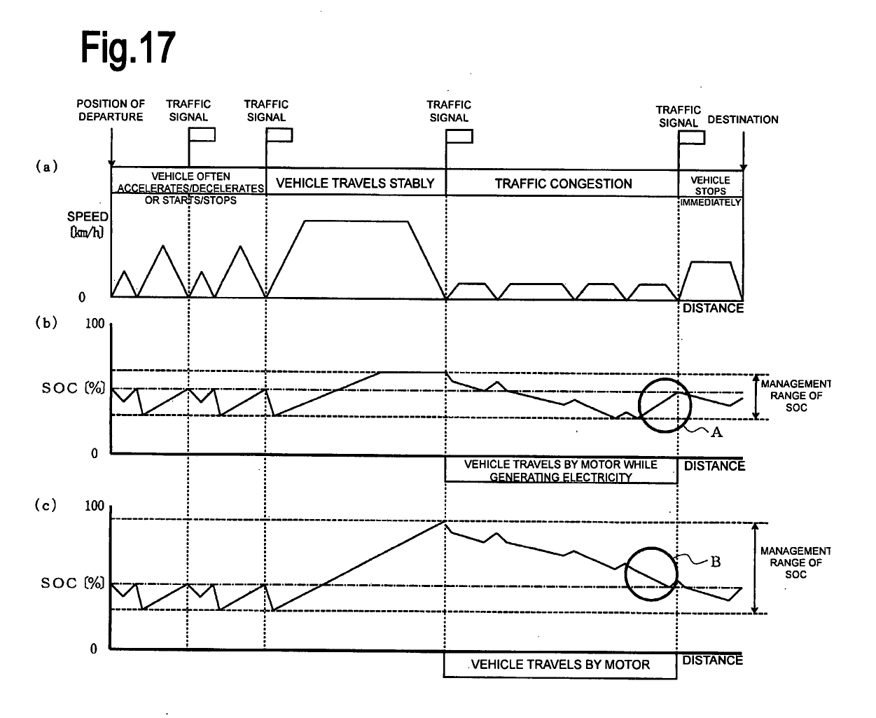

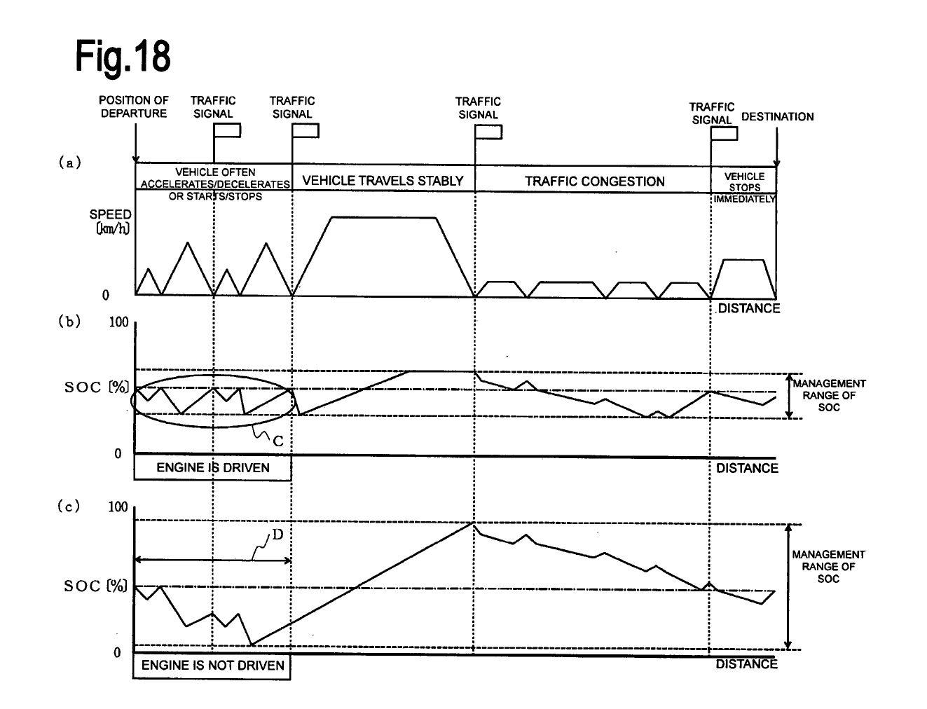

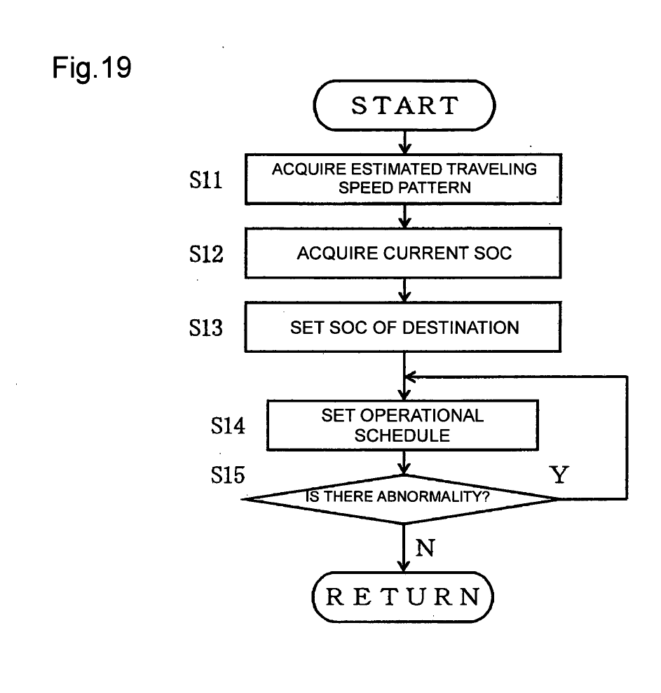

FIG. 17 shows a first example of a set schedule in the embodiment of the present invention. FIG. 18 shows a second example of a set schedule in the embodiment of the present invention. FIG. 19 is a flowchart showing an operation of a scheduling processing in the embodiment of the present invention.

First of all, the main control unit 26 acquires an estimated traveling speed pattern from the traveling pattern predicting portion 11 (step S11), and performs the scheduling processing for setting an operational schedule for controlling the operational states of the engine 21 and the motor 24 and the SOC of the battery 23 on the basis of the estimated traveling speed pattern. After having set the operational schedule, the main control unit 26 controls the operations of the engine 21, the engine control unit, the motor 24, the generator 22, and the inverter according to the operational schedule, and performs a traveling processing for causing the vehicle to travel.

After having acquired the estimated traveling speed pattern, the main control unit 26 acquires a current SOC detected by the capacity detecting sensor of the battery 23 (step S12). In this case, since the scheduling processing is performed immediately before the frequent route is followed, the current SOC is an SOC at a start position of the frequent route, namely, an SOC at a position of departure.

Then, the main control unit 26 sets an SOC at an end position of the frequent route, namely, an SOC at a destination (step S13). In this case, the SOC at the destination is equal, for example, to the SOC at the position of departure of the frequent route. However, the SOC at the destination can be set arbitrarily within a management range of SOC.

In the drive control system 10 for the hybrid vehicle of the present embodiment as well, as in the case of a generally employed hybrid vehicle, a management range of SOC as an electric charge accumulation amount of the battery 23 is set in advance, and an operational schedule is set such that the SOC is confined within the management range. As in the case of a generally employed battery, the voltage-current characteristic of the battery 23 fluctuates depending on SOC, and the life span of the battery 23 is shortened by too large an SOC or too small an SOC. For instance, the battery 23 may be destroyed if having been charged excessively. Thus, the management range set in advance is set, for example, such that maximum and minimum values of SOC become approximately 60[%] and 40[%] respectively, and the SOC of the battery 23 is so controlled as to be confined within the management range.

However, in the case where the generator 22 quite often generates regenerative current as in the case of a long downhill road, if the management range is fixed, the regenerative current is wasted without being allowed to be recovered by the battery 23 sufficiently. Hence, the amount of fuel consumption cannot be reduced sufficiently although the generator 22 quite often generates regenerative current.

Thus, the main control unit 26 sets an efficient operational schedule such that the amount of fuel consumption can be reduced sufficiently by allowing regenerative current to be recovered by the battery 23 sufficiently while the SOC is prevented from exceeding the management range by adjusting upper-limit and lower-limit values of the management range and by widening the management range as necessary (step S14). That is, the main control unit 26 sets an operational schedule corresponding to a minimum amount of fuel consumption in the engine 21 on the basis of an estimated traveling speed pattern.

Then, the main control unit 26 sets an operational schedule for controlling the operational states of the engine 21 and the motor 24 and the SOC of the battery 23 according to the estimated traveling speed pattern that has been acquired, and determines whether or not there is an abnormality in the set operational schedule (step S15). The abnormality means that the SOC at the destination included in the set operational schedule is different from an originally set value, or that the SOC included in the set operational schedule exceeds the management range. If there is an abnormality, the main control unit 26 sets an operational schedule again. It is also appropriate that pieces of information on fuel consumption amount and a vehicular system be included in the operational schedule, and that a determination on the presence of an abnormality in the operational schedule be made on the basis of the pieces of information on fuel consumption amount and the vehicular system.

For example, since the efficiency in traveling by the engine 21 is low in a congested section, it is desirable to travel by the motor 24. Thus, as shown in FIG. 17(a), in the case where a congested section is included in an estimated traveling speed pattern output by the traveling pattern predicting portion 11, namely, in the case where the occurrence of traffic congestion is predicted beforehand, the main control unit 26 sets a driving method such that the battery 23 is sufficiently charged before the congested section.

In the case where the upper-limit or lower-limit value of the management range of the SOC is not adjusted, the SOC changes as shown in FIG. 17(b). That is, since the vehicle travels by the motor 24 over a long distance in the congested section and consumes a large amount of current, it is necessary for the vehicle to travel in a generating travel mode wherein the engine 21 is in operation while the generator 22 generates electricity as indicated by “A”, so as to prevent the SOC from dropping below the lower-limit value. Hence, the amount of fuel consumption cannot be reduced sufficiently. Further, since the vehicle reaches the destination soon after passing the congested section, a sufficient amount of electricity cannot be generated, and the SOC at the destination cannot be equalized with the SOC at the position of departure either.

On the other hand, if the upper-limit value of the management range of the SOC is adjusted to be raised to a suitable value, the SOC changes as shown in FIG. 17(c). In this case, it can be detected that a regenerative section where regenerative current is generated exists in a section before the congestion section. Since the battery 23 can be sufficiently charged in the regenerative section, even if the vehicle travels by the motor 24 over a long distance in the congested section and consumes a large amount of current, the SOC can be held at a suitable value without operating the engine 21 as indicated by “B”. Hence, the amount of fuel consumption can be reduced sufficiently. Further, the SOC at the destination can also be equalized with the SOC at the position of departure.

For example, also in a section where the vehicle often accelerates/decelerates or starts/stops, since the efficiency in traveling by the engine 21 is low, it is desirable that the vehicle travel by the motor 24. Thus, as shown in FIG. 18(a), if a section where the vehicle often accelerates/decelerates or starts/stops is included in an estimated traveling speed pattern output by the traveling pattern predicting portion 11 and if a section where the vehicle can stably travel is included immediately following that section, the main control unit 26 sets a driving method such that the battery 23 is charged after the section where the vehicle often accelerates/decelerates or starts/stops has been passed.

In the case where the upper-limit or lower-limit value of the management range of the SOC is not adjusted, the SOC changes as shown in FIG. 18(b). That is, since the vehicle travels by the motor 24 over a long distance and consumes a large amount of current in the section where the vehicle often accelerates/decelerates or starts/stops, it is necessary for the vehicle to travel in a generating travel mode wherein the engine 21 is in operation and wherein the generator 22 generates electricity as indicated by “C”, so as to prevent the SOC from dropping below the lower-limit value. Therefore, the amount of fuel consumption cannot be reduced sufficiently.

On the other hand, if the lower-limit value of the management range of the SOC is adjusted to be reduced to a suitable value, the SOC changes as shown in FIG. 18(c). In this case, regenerative current can be recovered by the battery 23 before a start position of a regenerative section immediately following the section where the vehicle often accelerates/decelerates or starts/stops. Hence, the battery 23 can be charged sufficiently in the regenerative section. Therefore, even if the vehicle travels by the motor 24 over a long distance and consumes a large amount of current in the section where the vehicle often accelerates/decelerates or starts/stops, the SOC can be held within the management range without operating the engine 21 as indicated by “D”. Therefore, the amount of fuel consumption can be reduced sufficiently. In the section immediately following the section where the vehicle often accelerates/decelerates or starts/stops, the SOC can be recovered by sufficiently charging the battery 23. In the example shown in FIG. 18(c), the upper-limit value of the management range of the SOC is raised as well. This is because a congested section is included in the frequent route, as in the example shown in FIG. 17(c). In the case where no congested section is included in the frequent route, it is appropriate to adjust only the lower-limit value of the management range of the SOC.

As described hitherto, the main control unit 26 detects a regenerative section on the basis of an estimated traveling speed pattern, and sets an operational schedule such that regenerative current can be recovered by the battery 23 before a start position of the regenerative section. Therefore, no regenerative current is wasted. Further, since the operational schedule is set such that all the regenerative current generated in the regenerative section can be recovered by the battery 23, the amount of fuel consumption can be reduced sufficiently.

Next, the operation of the traveling processing will be described.

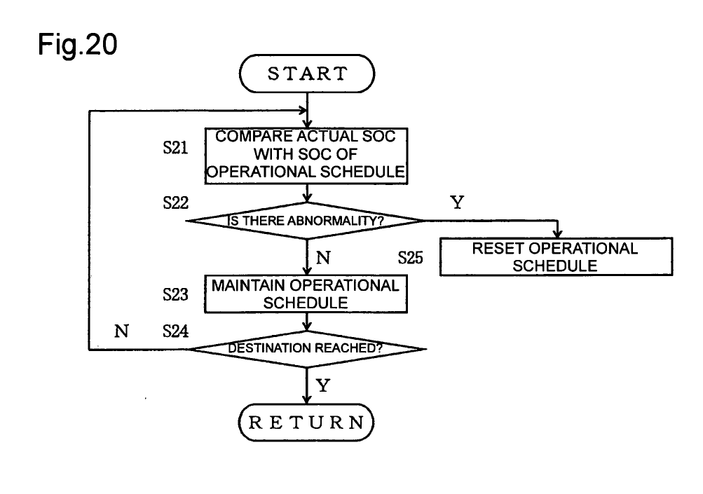

FIG. 20 is a flowchart showing the operation of the traveling processing in the embodiment of the present invention.

If the vehicle starts traveling along the frequent route, the main control unit 26 controls the operations of the engine 21, the engine control unit, the motor 24, the generator 22, and the inverter according to the set operational schedule. In this case, the main control unit 26 acquires an SOC detected by the capacity detecting sensor of the battery 23, namely, an actual SOC on a real-time basis, compares the acquired SOC with an SOC included in the operational schedule (step S21), and determines whether or not there is an abnormality in the acquired SOC (step S22).

A traveling speed pattern of the vehicle in actually traveling along the route does not completely coincide with the estimated traveling speed pattern. Therefore, changes in actual SOC are considered to be different from changes in the SOC included in the aforementioned operational schedule. Hence, if the difference between an actual SOC and the SOC included in the operational schedule remains above a preset threshold for a while, the main control unit 26 determines that there is an abnormality, and resets an operational schedule from a current position of the vehicle at that moment to a destination (step S25). If there is no abnormality, the main control unit 26 continues to perform the control according to the operational schedule (step S23). Also in the case where an actual SOC has risen above or dropped below the upper-limit or lower-limit value of the management range, the main control unit 26 may determine that there is an abnormality, and may reset an operational schedule from a current position of the vehicle to a destination. In addition, if an actual SOC has risen above or dropped below the upper-limit or lower-limit value of the management range, the main control unit 26 may control the operations of the engine 21, the engine control unit, the motor 24, the generator 22, and the inverter so that the SOC is confined again within the management range, and may cause charge and discharge of the battery 23.

If the current position of the vehicle remains off the frequent route for a while, the main control unit 26 determines that the vehicle does not travel along the frequent route, acquires navigation information and the like from the navigation data base 12, and resets an operational schedule from the current position of the vehicle to a destination. In addition, also in the case where the current position of the vehicle has deviated from the frequent route because of temporary detour or the like, the main control unit 26 resets an operational schedule from the current position of the vehicle to a destination. If the current position of the vehicle has not greatly deviated from the frequent route, the main control unit 26 continues to perform control according to the set operational schedule, as in the case where the difference between the actual SOC and the SOC included in the operational schedule is equal to or smaller than the preset threshold.

Then, the main control unit 26 determines whether or not the vehicle has reached the destination (step S24). If the vehicle has not reached the destination, the main control unit 26 repeats the aforementioned operation.

As described hitherto, in the present embodiment, the traveling pattern predicting portion 11 of the drive control system 10 of the hybrid vehicle generates candidate traveling speed patterns by analyzing traveling data in the case of traveling along a frequent route that is frequently followed for the purpose of going to work, going to school, going shopping, or the like, and outputs a suitable estimated traveling speed pattern corresponding to current traveling environment data in traveling along the frequent route. Then, the main control unit 26 sets an operational schedule on the basis of the estimated traveling speed pattern, and controls the operations of the engine 21, the engine control unit, the motor 24, the generator 22, and the inverter according to the operational schedule. Thus, the SOC can be held at a suitable value, and the amount of fuel consumption of the engine 21 can be reduced sufficiently.

In this case, the traveling pattern predicting portion 11 divides the frequent route into short sections, and generates candidate traveling speed patterns in each of the short sections not on the basis of traveling environment data such as date, hour, day of the week, weather and the like but only on the basis of traveling data. Thus, the candidate traveling speed patterns can be generated on the basis of a great number of traveling data. Therefore, the precision of the candidate traveling speed patterns can be enhanced.

Further, the traveling pattern predicting portion 11 extracts traveling data matching current traveling environment data, extracts a candidate traveling speed pattern of a set to which a greatest number of the traveling data belong, and defines the extracted candidate traveling speed pattern as an estimated traveling speed pattern. Thus, it is possible to output a suitable estimated traveling speed pattern corresponding to the current traveling environment data.

That is, in the case where candidate traveling speed patterns are generated, they are generated not on the basis of traveling environment data but only on the basis of traveling data obtained in following the same frequent route. In the case where an estimated traveling speed pattern for a frequent route to be followed from now on is output, a candidate traveling speed pattern of a set to which a greatest number of the past traveling data matching the current traveling environment data belong is selected. Thus, a greater number of traveling data can be used in generating candidate traveling speed patterns, and the selection of traveling data can be carried out suitably on the basis of traveling environment data in outputting an estimated traveling speed pattern.

In addition, the traveling pattern predicting portion 11 stores the past traveling data for each of the short sections into the candidate traveling speed pattern storing portion 16 as some candidate traveling speed patterns. Therefore, aggregation of data and reduction of storage capacity can be achieved.

Furthermore, the traveling pattern predicting portion 11 outputs an estimated traveling speed pattern by extracting candidate traveling speed patterns matching traveling environment data in traveling from now on. Thus, the burden of calculation processings is reduced in comparison with a case where an estimated traveling speed pattern is output on the basis of an enormous volume of the past traveling data, and the estimated traveling speed pattern can be output quickly.

Furthermore, in setting a schedule for efficiently traveling along the route, the main control unit 26 adjusts an upper-limit or lower-limit value of a management range of SOC, widens the management range as necessary, and sets a driving method. Thus, it is possible to set an efficient driving method such that the amount of fuel consumption can be reduced sufficiently by allowing the battery 23 to sufficiently recover regenerative current while preventing the SOC from exceeding the management range.

It is to be noted herein that the present invention is not limited to the aforementioned embodiment but can be modified in various manners on the basis of the concept thereof, and that modifications of the present invention should not be excluded from the scope thereof.

As described hitherto in detail, according to the present invention, a vehicle traveling speed pattern estimation device comprises traveling information storing means for storing traveling data and traveling environment data as mutually associated data, candidate traveling speed pattern generating means for generating a candidate traveling speed pattern on the basis of the traveling data, and estimated traveling speed pattern outputting means for extracting a candidate traveling speed pattern matching current traveling environment data and outputting an estimated traveling speed pattern for a route to be followed from now on.

Herein, in the case where a candidate traveling speed pattern is generated, the candidate traveling speed pattern is generated not on the basis of traveling environment data but only on the basis of traveling data. In the case where an estimated traveling speed pattern for a route to be followed from now on is output, a candidate traveling speed pattern matching current traveling environment data is selected. Therefore, an estimated traveling speed pattern can be output with high precision under a light burden of calculation processings.

Another vehicle traveling speed pattern estimation device further comprises frequent route specifying means for specifying a frequent route on the basis of the traveling data, and sectionally dividing means for dividing the frequent route into short sections. The candidate traveling speed pattern generating means generates the candidate traveling speed pattern for each of the short sections. The estimated traveling speed pattern outputting means extracts a candidate traveling speed pattern for each of the short sections, and outputs an estimated traveling speed pattern for a frequent route to be followed from now on.

In this case, since the estimated traveling speed pattern for the frequent route that is frequently followed is output, the estimated traveling speed pattern can be output quickly with high precision. The frequent route is divided into the short sections, and the candidate traveling speed pattern is extracted for each of the short sections. Therefore, the estimated traveling speed pattern can be output quickly with higher precision.

In still another vehicle traveling speed pattern estimation device, the candidate traveling speed pattern generating means classifies traveling data for each of the short sections on the basis of an average traveling speed for each of the short sections or a degree of similarity among traveling speed patterns for each of the short sections, and generates, as the candidate traveling speed pattern, a traveling speed pattern representing a set of the classified traveling data for each of the short sections.

In this case, classification is carried out on the basis of an average traveling speed for each of the short sections or a degree of similarity among traveling speed patterns for each of the short sections, and a traveling speed pattern representing a set of classified traveling data for each of the sections is defined as a candidate traveling speed pattern. Therefore, a suitable candidate traveling speed pattern can be generated.

1. A vehicle traveling speed pattern estimation device comprising:
traveling information storing means for storing traveling data and traveling environment data as mutually associated data;
candidate traveling speed pattern generating means for generating a candidate traveling speed pattern on the basis of the traveling data; and
estimated traveling speed pattern outputting means for extracting a candidate traveling speed pattern matching current traveling environment data and outputting an estimated traveling speed pattern for a route to be followed from now on.

2. The vehicle traveling speed pattern estimation device according to claim 1, further comprising:
frequent route specifying means for specifying a frequent route on the basis of the traveling data; and
sectionally dividing means for dividing the frequent route into short sections, wherein
the candidate traveling speed pattern generating means generates the candidate traveling speed pattern for each of the short sections, and
the estimated traveling speed pattern outputting means extracts a candidate traveling speed pattern for each of the short sections, and outputs an estimated traveling speed pattern for a frequent route to be followed from now on.

3. The vehicle traveling speed pattern estimation device according to claim 2, wherein
the candidate traveling speed pattern generating means classifies the traveling data for each of the short sections on the basis of an average traveling speed for each of the short sections or a degree of similarity among traveling speed patterns for each of the short sections, and generates a traveling speed pattern representing a set of the classified traveling data for each of the short sections as the candidate traveling speed pattern.

4. The vehicle traveling speed pattern estimation device according to claim 2, wherein
the estimated traveling speed pattern outputting means extracts traveling data matching current traveling environment data for each of the short sections, extracts a candidate traveling speed pattern representing a set to which a greatest number of the traveling data belong, and outputs the estimated traveling speed pattern.

5. The vehicle traveling speed pattern estimation device according to claim 1, wherein
the traveling environment data include date, hour, day of the week, information on operation of on-vehicle equipments such as a wiper and a headlight, and sensing information obtained from on-vehicle sensors such as a raindrop sensor.

6. A vehicle traveling speed pattern estimation method comprising the steps of:
storing traveling data and traveling environment data as mutually associated data;
generating a candidate traveling speed pattern on the basis of the traveling data; and
extracting a candidate traveling speed pattern matching current traveling environment data and outputting an estimated traveling speed pattern for a route to be followed from now on.
